(19) United States
(12) Patent Application Publication
(10) Pub. No.: US 2005/0033723 A1
(43) Pub. Date: Feb. 10, 2005

(54) Method, system, and computer program product for sorting data

(76) Inventors: David A. Selby, North Boarhunt Near Fareham (GB); Vincent P. Thomas, Severna Park, MD (US); Stephen Todd, Winchester (GB)

Correspondence Address: Mark D. Simpson, Esquire;Synnestvedt & Lechner, 2600 Aramark Tower, 1101 Market Street, Philadelphia, PA, 19107-2950, US

(21) Appl. No.: 10/637,272

(22) Filed: Aug. 8, 2003

(51) Int. Cl. G06F 7/00

(52) U.S. Cl. 707/1

(57) ABSTRACT

“Microbins” are established to be used for automatic data-point-by-data-point sorting of outcomes of a model. These microbins have much finer “resolution” than standard decile bins. The predicted values are mapped to their respective microbins. As an actual outcome is obtained, it is automatically inserted into the microbin associated with its predicted value. By limiting the predicted score values to three decimal places (or rounding them to three decimal places), each predicted value will have a single microbin in which to be placed, rather than bunching a range of predicted values into a decile bin. To establish the decile bins needed to prepare a standard 10-bin lift chart, the first 1/10th of the actual outcomes are grouped in a first bin, the second 1/10th of the actual outcomes are grouped in a second bin, etc. In this manner, the actual outcomes are “sorted” on the fly rather than after the fact.

### BACKGROUND OF THE INVENTION

1. Field of the Invention

The present invention relates to the evaluation of data and, more particularly, to a method, system, and computer program product for sorting data for a diagnostic tool such as a lift chart.

2. Description of the Related Art

Data mining is a well known technology used to discover patterns and relationships in data. Data mining involves the application of advanced statistical analysis and modeling techniques to the data to find useful patterns and relationships, typically using a data mining model. The resulting patterns and relationships are used in many applications in business to guide business actions and to make predictions helpful in planning future business actions.

A data mining model outputs a continuous value, a probability that an event or outcome will actually occur. This is typically expressed as a known, bounded value, such as a value from 0 to 1, where 0 represents “false” or “negative” (i.e., the outcome will not or did not occur) and 1 represents “true” or “positive” (i.e., the outcome will or did occur). Values in-between 0 and 1 indicate the probability that the outcome will or will not occur, with numbers closer to 0 representing a lower likelihood of occurrence and numbers closer to 1 representing a higher likelihood of occurrence. This probability is used to predict the certainty of an outcome of the event for a real data set (as opposed to a training or test data set).

The training of models requires a set of records with known outcomes. The trick of data mining is to develop a set of variables that best describe the outcome to be predicted. Most typically, however, the variables are constrained by the ability to record/collect data.

A lift chart is a diagnostic tool used by data mining analysts to evaluate the effectiveness of a data mining model. The chart produced is typically a histogram where each bar represents a decile (typically) of the population sorted, by their propensity scores, in descending order. Each bar represents the percentage of scores that are positive in that decile, versus all of the scores in that decile. Both actual and predicted answers are provided, and from this a data chart is developed

A typical application of lift charts is in connection with marketing/advertising and determining whether or not a potential recipient of advertising will likely respond to the offer. The scoring model for such an application has a binary outcome, that is, the model predicts the outcome of an event, such as whether a potential customer will or will not apply for a loan from a bank as a result of the bank's advertising, rather than the prediction of a variable “continuous” event (such as predicting the value of a loan that an anticipated loan customer may wish to take, which could be one of many different values).

To produce a lift chart, data must be organized and sorted. The prior art method for organizing and sorting the data for a lift chart requires a dataset to be sorted by the predicted score derived from the model (a first “pass” through the data); obtaining actual outcomes for each data point (e.g., for each customer); and grouping the actual outcomes into deciles based on the predicted score (a second “pass” through the data). Thus, the actual outcomes of the top 10% of the predicted scores are in the first bin; the actual outcomes for the second 10% of the predicted scores are in the second bin, etc. The number of actual positive answers in a bin are counted, as are the total number of records in the same bin. This is performed for all bins. Dividing the number of positive answers by the total and multiplying by 100 produces the percentage correct in that bin for that decile. This process is performed for each decile until all ten are processed, and the results graphed.

The above-described process can be computationally intensive, particularly the sorting of the records, with their associated outcomes, by their scores. The process requires multiple passes through the data set, and all of the actual outcomes have to be obtained before the actual scores can be grouped into the deciles.

Accordingly, it would be desirable to have a method, system, and computer program product which allows data requiring sorting (such as data to be used for lift charts) to be placed in sorted order as it is obtained rather than having to wait to do the sorting until after all of the data has been obtained.

### SUMMARY OF THE INVENTION

In accordance with the present invention, outcomes are “micro-binned” as they are gathered, and once all of the outcomes are gathered, the lift chart can be prepared immediately, rather than requiring the post-gathering sorting step of the prior art. By microbinning the outcomes as they are gathered, the use of the processing power of the device processing the data is maximized, and the results achieved more quickly. Among other positive benefits, this approach allows the microbins to be populated in parallel.

The above benefits are obtained, in accordance with the present invention, by establishing “microbins” to hold the gathered outcomes. These microbins have much finer “resolution” than standard decile bins (e.g., for predicted values at or between 0.001 and 1.000, one thousand (1,000) microbins (one for each increment of 0.001) can be established). A mapping is established associating each microbin with one of, or a range of, the possible predicted values. As an actual outcome is obtained, it is automatically inserted into the microbin associated with its predicted value. The microbins are arranged in sequential order, preferably in reverse sequential order (e.g., 1000; 999; 998; . . . ; 001). By limiting the predicted score values to three decimal places, each predicted value will be mapped to one of the microbins (e.g., one of the 1000 microbins in this example), rather than bunching a range of predicted values into a decile bin, and because the microbins are arranged sequentially, there is no need to sort them. They are automatically ordered as they are placed in their microbins. Then, to establish the decile bins needed to prepare a standard lift chart (assuming 10 bins for the lift chart), the first 1/10th of the actual outcomes (beginning with the largest-number microbin and moving downward towards the first microbin) are grouped in a first bin, the second 1/10th of the actual outcomes are grouped in a second bin, etc. In this manner, the actual outcomes are sorted “on the fly” rather than after the fact. This saves processing time and simplifies the creation of the subsequent lift chart.

To handle situations where the number of predicted values are extremely large (e.g., where floating point arithmetic is used and the number of decimal digits is greater than the three described above), a rounding/limiting step is included to map the larger number of possible predicted values to the smaller number of microbins.

### BRIEF DESCRIPTION OF THE DRAWINGS

FIG. 1 is a table presenting an example set of predicted probability scores for a set of 50 potential customers targeted for marketing efforts by a hypothetical company;

FIG. 2 illustrates the result of performing the sorting step;

FIG. 3 shows the binning process, whereby the first one-tenth of the values, beginning from the highest predicted value and proceeding to the lowest, are grouped in bins;

FIG. 4 illustrates the percentage of true results for each bin charted in a histogram to create a lift chart;

FIG. 5 partially illustrates the microbins of the present invention; and

FIG. 6 is a flowchart illustrating an example of the steps performed in accordance with the present invention to derive and organize the data for use in creating the lift chart.

### DETAILED DESCRIPTION OF THE PREFERRED EMBODIMENTS

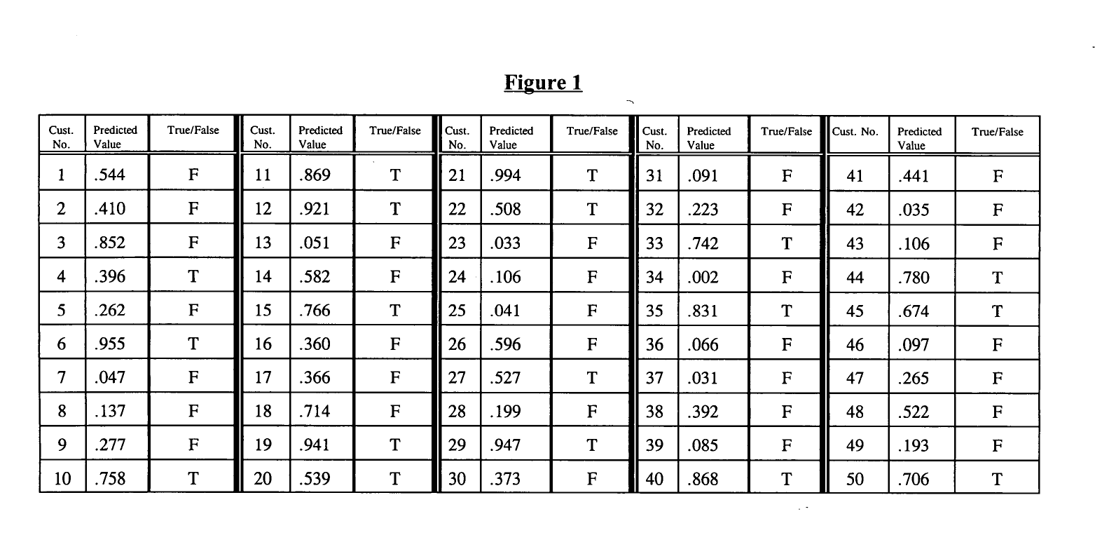

To better understand the present invention, an example of how lift chart data is derived using prior art techniques is beneficial. FIG. 1 is a table presenting an example set of predicted probability scores for a set of 50 potential customers targeted for marketing efforts by a hypothetical company. FIG. 1 also shows the actual outcome for each customer, indicated by a “T” for a true or positive outcome, and an “F” for a false or negative outcome. It is understood that this extremely small set of customers and data points is being used for the purpose of example only, and that in actual application, the present invention would typically be used with much larger data sets, e.g., on the order of hundreds of thousands, or millions of records.

Referring to FIG. 1, the customers are listed sequentially according to customer number (1 through 50) and next to the customer number is the probability (predicted) score for each customer based upon a standard scoring model that is not the subject of this invention. For example, customer # 1 has a predicted probability value of 0.544, customer # 15 has a predicted probability value of 0.766, etc. As explained above, these probability values represent the probability that an event will be “true” (i.e., that the customer will respond to the marketing effort) or “false” (that the customer will not respond to the marketing effort). A value of 0.001 represents “highly unlikely” and a value of 0.999 represents “highly likely”. As noted above, the actual T/F outcome is also shown. As each actual outcome is determined, it is associated with its customer number. Since the method of determining the actual outcome is not relevant to the present invention, it is not discussed further herein.

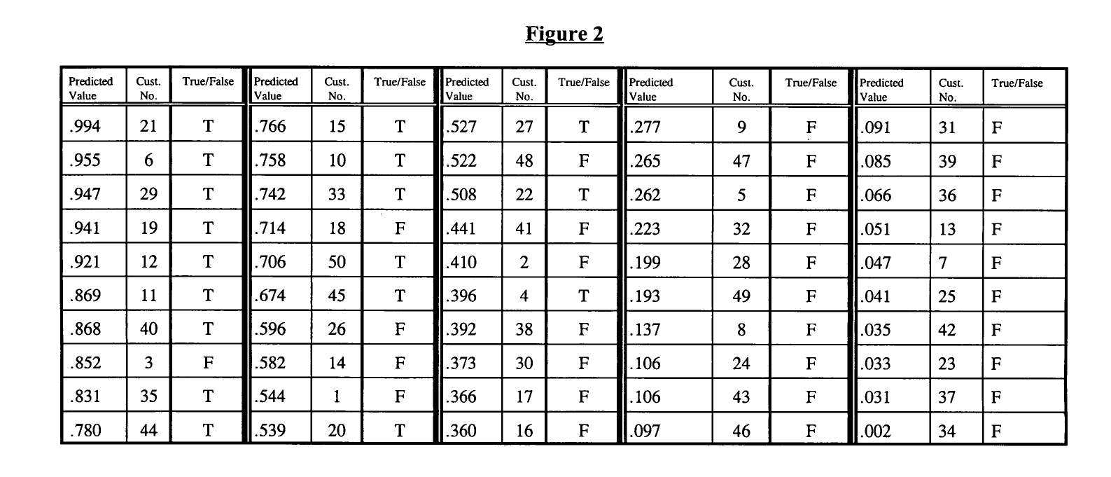

In conventional lift chart construction, several passes through the data must be performed. In order to prepare a lift chart, the data must be reorganized so that the customers with the highest predicted values (those most likely to have positive outcomes) are first, and those with smaller predicted values (those least likely to have positive outcomes) are last. Thus, the first step involves ordering the customers by their predicted value, highest to lowest. FIG. 2 illustrates the result of performing this sorting step, where the highest predicted value, 0.994, associated with customer #21, is now at the top of the list and the smallest predicted value, 0.002, associated with customer #34, is at the end of the list. This process is computationally intensive, particularly when dealing with thousands or millions of datapoints or records. In addition, the ordering process cannot be initiated until all of the predicted values are computed, causing additional processing delays.

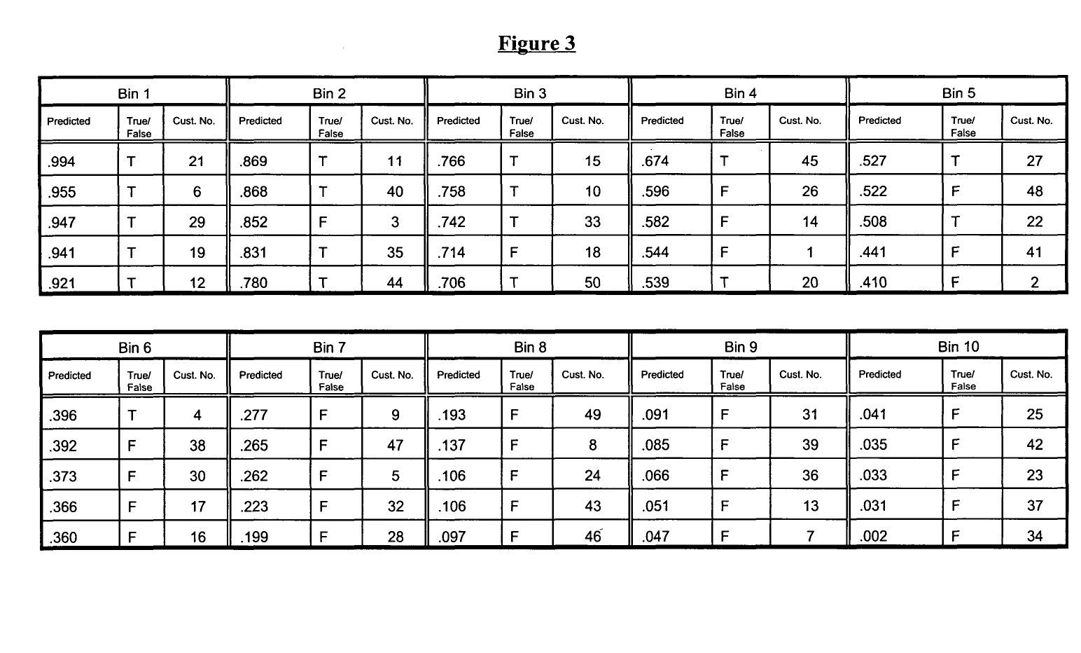

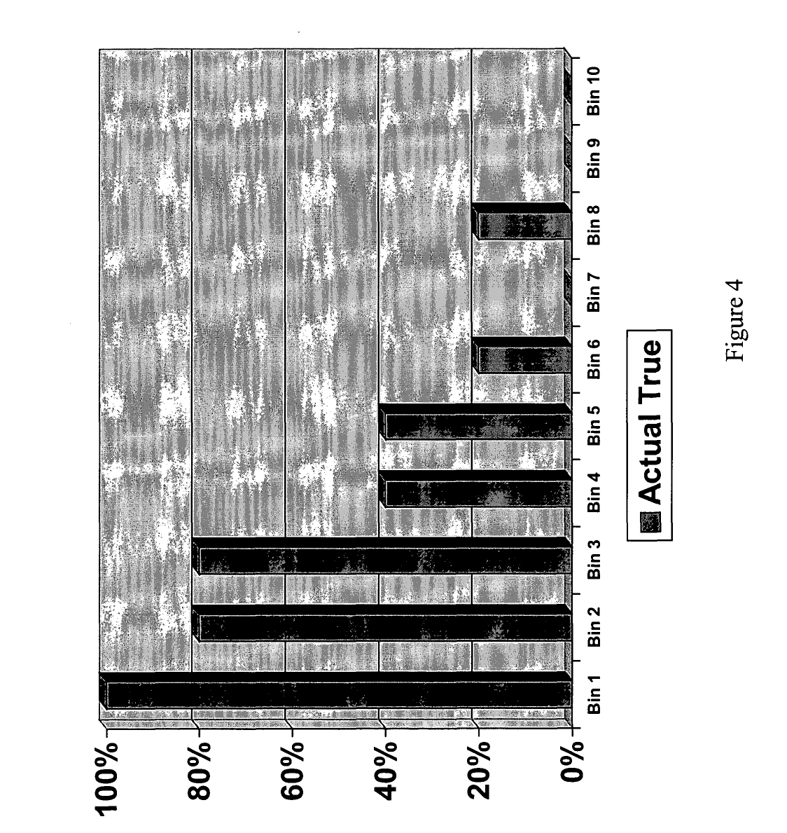

Finally, FIG. 3 shows the binning process, whereby the first one-tenth of the values, beginning from the highest predicted value and proceeding to the lowest, are grouped in bins. Since the number of prospective customers is 50, there will be ten bins of five customer data points each, as illustrated in FIG. 3. FIG. 3 also shows the actual result (true or false) for each data point. Then, as is well known, to create a lift chart, the percentage of true results for each bin are charted in a histogram, as illustrated in FIG. 4.

This process has been used for years and operates adequately, but it suffers from having to use large amounts of computational resources, first to sort the dataset by predicted scores, and then to group the scores into deciles.

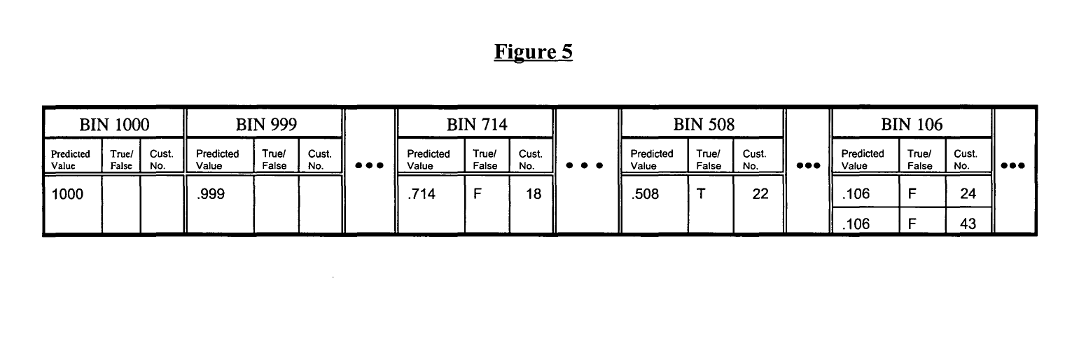

FIG. 5 partially illustrates the microbins of the present invention. In accordance with the present invention, as the data set is processed by the model, the results are automatically placed in a microbin that is associated with (mapped to) that result. The present invention takes advantage of the fact that the input, in this example the predicted values, are all within a known bounded range of 0-1.0. More specifically, in accordance with the present invention, a number of possible values is established, e.g., 1000, and then an equal number of microbins (e.g., 1000) are established. (e.g., for values 0.001-1.000). Values that fall outside of the range (e.g., 0.0074; 0.13627; etc.) are rounded according to a predetermined rounding rule so that they can be associated with one of the microbins. The exact rounding rule used is unimportant as long as it is consistently applied.

In this manner, each score has a unique microbin with which it is associated, and because the microbins are small in size, the ordering of the values occurs as the values are placed in the microbins instead of having to perform one or more sorts through the values to get them in the proper sorted order. The microbins are partially illustrated in FIG. 5. For example, referring back to FIG. 1, when the actual outcome (T or F) is obtained for customer #22, that T/F value is placed in microbin #508 (corresponding to its predicted value of 0.508) as shown in FIG. 5. For customer 18, the actual outcome “F” is placed in microbin #714, corresponding to its predicted value of 0.714. Microin 106 of FIG. 5 illustrates an example where there are multiple customers with the same predicted value. As shown in FIG. 5, microbin 106 contains entries for both customer #24 and customer #43. Microbins 1000 and 999 are shown empty; however, if during the process a customer having a predicted value of 1.000 or 0.999 is processed, the appropriate True/False values for them will be input into microbin 1000 or microbin 999. Likewise, if there were predicted values that exceeded the 3 decimal places used in this example (e.g., if there were predicted values having 4 or more decimal places), they would be rounded to 3 decimal places using a predetermined rule and associated with the appropriate microbin for that 3-decimal-place number.

In this manner, as the actual outcomes are obtained, they are automatically sorted because they are placed in a microbin specific to the predicted value, and thus are already in sequential order (highest to lowest predicted values). Once all of the data has been processed and placed in the microbins, it is a simple matter to start from the highest numbered microbin (e.g., microbin 1000) and take the first one-tenth of the actual values, moving from the highest to the lowest numbered microbin, and use the first one-tenth of the values as the first bin for lift chart purposes.

Take a highly simplified example in which there are exactly 1000 customers, and each one has a different predicted value, starting with 0.001 and going up to 1.000. In this example, there would be 1000 microbins, with each microbin containing exactly one actual outcome, and thus the first one-tenth of the microbins would comprise the first bin, meaning the microbins 1000-901 would make up bin #1; microbins 900-801 would make up bin #2; etc. On the other hand, if there were 100 customers having a predicted value of 1.000, then values in microbin 1000 would comprise the first bin (since one-tenth (100/1000) of the values would be in microbin 1000).

In actual practice, there would most often be hundreds of thousands of values distributed among the 1000 bins (in this example). Using the method of the present invention, the computationally intensive sorting steps described above with respect to the prior art are unnecessary, and the graphing to form the lift chart can occur right away, as soon as all the actual outcomes have been established.

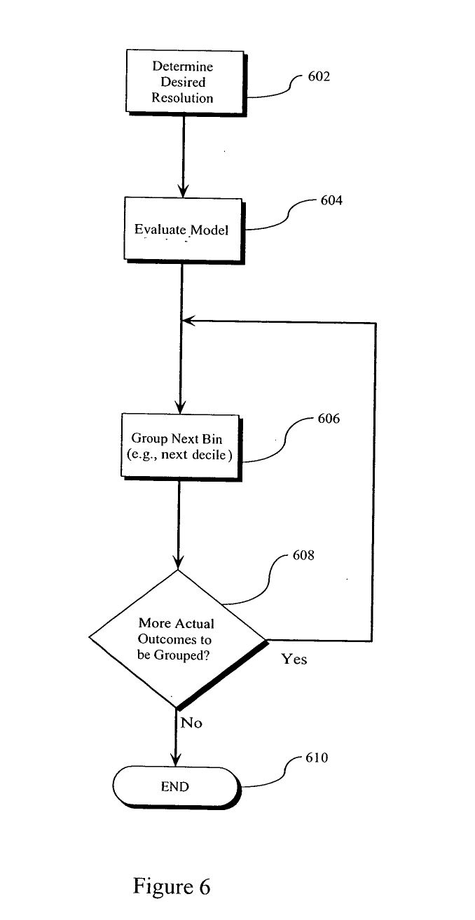

FIG. 6 is a flowchart illustrating an example of the steps performed in accordance with the present invention to derive and organize the data for use in creating the lift chart. At step 602, a determination is made as to the resolution of the lift chart. For example, in the example above, where three decimal places are used for the predicted data values between 0 and 1, one thousand (1,000) microbins are required to give this three-decimal-place resolution. If higher resolution is desired (e.g., four-decimal-place resolution), then additional bins will be required (e.g., for four-decimal-place resolution, 10,000 microbins would be required). At step 604, the model is evaluated (e.g., a test set is run through the model, producing a data set containing predicted values and actual outcomes). As the model is being evaluated, each outcome result is placed in its appropriate microbin. Thus, rather than having to wait for the completion of the evaluation of the model before sorting the results, using the present invention inherently sequences the values as the model is evaluated.

At step 606, the total records for which outcomes have been gathered are grouped based on the number of bins to be used. For example, if decile bins are being used, the first 1/10 of the total records for which actual outcomes have been gathered are used for the first decile. The number of true answers is charted against the number of total answers in the first decile, and this creates the first bar graph of the lift chart in a known manner. At step 608, a determination is made as to whether or not there are any more actual outcomes to be grouped. The process repeats for the next 1/10 of the total records for which actual outcomes have been gathered, until all 10 bins have been established and, then the process ends (step 610).

In the simple example described above, it has been assumed that the outcome is not any number on the range 0 to 1, but rather a number computed to a certain accuracy (for example, to three decimal digits, four decimal digits, etc). This limitation of accuracy also limits the number of possible predicted values; so that this set of limited-accuracy possible predicted values map directly to microbins (for three digit accuracy the mapping is to 1000 microbins) as described above.

Such computation to a limited accuracy (especially a decimal accuracy) is convenient for human description, but may not be efficient for machine computation, and the present invention is not limited to the simple example described above. For example, in a true computer implementation of the present invention, it is more likely that computation of outcomes will be performed using floating point arithmetic. This presents a very large range of possible predicted values; this range is not infinite but is considerably larger than the number of microbins that could efficiently be used. Therefore, a more practical way to map the large number of possible predicted outcomes to a smaller, more manageable number of microbins is to compute the outcome in the usual way (e.g., as per prior art techniques) as a floating point number, and then apply a simple mapping of possible predicted outcomes onto the set of microbins, to essentially “round off” the outcomes to associate them with one of the microbins.

For example, where there are N microbins, a suitable mapping is a simple linear mapping:
bin#=truncate(ComputedOutcome*N)+1
This gives the same effect as computation of the outcome to a more limited accuracy. The mapping simply limits the precision of the outcome so that the “mapped outcome” is the same as the “limited precision” outcome. For example, where N=1000, when one ComputedOutcome=0.123456 and another ComputedOutcome=0.123987, both are both mapped by the above formula to bin#=124.

The above example assumes that the distribution of outcome values is approximately linear, and this linearity is used in the rounding process to map possible predicted values to microbins. Where there is evidence known in advance that indicates some underlying non-linear trend in the distribution of outcomes, the mapping of possibile predicted value to microbins may take advantage of this trend using an appropriate non-linear mapping. The aim is that as far as possible all microbins should have an equal population. This will give the best possible result in the final redistribution from microbins to bins; thus, fewer microbins can be used for a given quality of final result.

Further it should be noted that the assignment of a record into a microbin is inherently a parallel operation. Large parallel databases can therefore take advantage of this technique. The SQL statement below can perform the microbinning,

select

floor( .5 + 1000 * SCORE) as microbin
,sum(ACTUAL) as sum_true_in_microbin
,count(ACTUAL) as total_in_microbin

from Table_Containing_Scores_and_Actuals
group by floor( .5 + 1000 * SCORE)
order by floor( .5 + 1000 * SCORE) desc

The remaining task is to gather the 1000 microbins into the decile bins. For a 50 node parallel database with 10 millions records, only the 50 sets of 1000 microbin counts need to be brought back to the coordinator node rather than all 50 million records; this represents a significant performance increase.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the disclosure and drawings support combinations of means for performing the specified functions, combinations of steps for performing the specified functions, and program instruction means for performing the specified functions.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a computer being used to analyze and graph the data. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Although the present invention has been described with respect to a specific preferred embodiment thereof, various changes and modifications may be suggested to one skilled in the art and it is intended that the present invention encompass such changes and modifications as fall within the scope of the appended claims.

1. A method for automatically arranging, in a predetermined order, the actual outcomes of the processing of a data set by a model, comprising the steps of:
establishing a plurality of microbins for storing the actual outcomes;
establishing a mapping from each possible predicted value to said microbins such that each microbin is associated with a range of said possible predicted values;
processing said data set through said model and identifying an actual outcome for each data point in said data set; and
storing said actual outcomes in the microbin associated by said mapping with the predicted value that corresponds with said actual outcome.

2. The method of claim 1, wherein said mapping step includes at least the step of identifying each microbin using a number corresponding to the range of possible predicted values with which it is associated.

3. The method of claim 2, wherein said step of establishing a plurality of microbins includes at least the step of arranging the microbins sequentially with respect to their identification number.

4. The method of claim 3, further comprising the step of:
dividing the number of data points in said data set by a predetermined value N; and
grouping said actual outcomes into N bins, identified as X, X+1, X+2 . . . N, where X=1, whereby the first 1/N of said actual outcomes, beginning with those in the highest numbered microbin and moving sequentially downward, are placed in bin X; the second 1/N of said actual outcomes are placed in bin X+1; and the process is repeated until all of said actual outcomes have been placed in one of said N bins.

5. The method of claim 4, wherein said actual outcomes can be either positive or negative outcomes, further comprising the step of:
for each of said N bins, dividing the number of positive actual outcomes therein by the number of actual outcomes in said bin, thereby establishing data in a form suitable for graphing in a lift chart.

6. A system for automatically arranging, in a predetermined order, the actual outcomes of the processing of a data set by a model, comprising:
means for establishing a plurality of microbins for storing the actual outcomes;
means for establishing a mapping from each possible predicted value to said microbins such that each microbin is associated with a range of said possible predicted values;
means for processing said data set through said model and identifying an actual outcome for each data point in said data set; and
means for storing said actual outcomes in the microbin associated by said mapping with the predicted value that corresponds with said actual outcome.

7. The system of claim 6, wherein said means for mapping includes means for identifying each microbin using a number corresponding to the range of possible predicted values with which it is associated.

8. The system of claim 7, wherein said means for establishing said plurality of microbins includes means for arranging the microbins sequentially with respect to their identification number.

9. The system of claim 8, further comprising:
means for dividing the number of data points in said data set by a predetermined value N; and
means for grouping said actual outcomes into N bins, identified as X, X+1, X+2 . . . N, where X=1, whereby the first 1/N of said actual outcomes, beginning with those in the highest numbered microbin and moving sequentially downward, are placed in bin X; the second 1/N of said actual outcomes are placed in bin X+1; and the process is repeated until all of said actual outcomes have been placed in one of said N bins.

10. The system of claim 9, wherein said actual outcomes can be either positive or negative outcomes, further comprising:
for each of said N bins, means for dividing the number of positive actual outcomes therein by the number of actual outcomes in said bin, thereby establishing data in a form suitable for graphing in a lift chart.

11. A computer program product recorded on computer readable medium for automatically arranging, in a predetermined order, the actual outcomes of the processing of a data set by a model, comprising:
computer-readable means for establishing a plurality of microbins for storing the actual outcomes;
computer-readable means for establishing a mapping from each possible predicted value to said microbins such that each microbin is associated with a range of said possible predicted values;
computer-readable means for processing said data set through said model and identifying an actual outcome for each data point in said data set; and
computer-readable means for storing said actual outcomes in the microbin associated by said mapping with the predicted value that corresponds with said actual outcome.

12. The computer program product of claim 11, wherein said computer-readable means for mapping includes computer-readable means for identifying each microbin using a number corresponding to the range of possible predicted values with which it is associated.

13. The computer program product of claim 12, wherein said computer-readable means for establishing said plurality of microbins includes computer-readable means for arranging the microbins sequentially with respect to their identification number.

14. The computer program product of claim 13, further comprising:
computer-readable means for dividing the number of data points in said data set by a predetermined value N; and
computer-readable means for grouping said actual outcomes into N bins, identified as X, X+1, X+2 . . . N, where X=1, whereby the first 1/N of said actual outcomes, beginning with those in the highest numbered microbin and moving sequentially downward, are placed in bin X; the second 1/N of said actual outcomes are placed in bin X+1; and the process is repeated until all of said actual outcomes have been placed in one of said N bins.

15. The computer program product of claim 14, wherein said actual outcomes can be either positive or negative outcomes, further comprising:
for each of said N bins, computer-readable means for dividing the number of positive actual outcomes therein by the number of actual outcomes in said bin, thereby establishing data in a form suitable for graphing in a lift chart.

16. A method for automatically arranging, in a predetermined order, the actual outcomes of the processing of a data set by a model, comprising the steps of:
establishing a plurality of microbins for storing the actual outcomes;
establishing a mapping from possible predicted values to microbins such that each microbin is associated with a range of said possible predicted values;
processing said data set through said model and identifying an actual outcome for each data point in said data set; and
storing said actual outcomes in the microbin associated by said mapping with the predicted value that corresponds with said actual outcome.

17. The method of claim 16, wherein:
all of said ranges of possible predicted values are of equal size; and
said mapping is accomplished by multiplying an actual outcome by the number of bins and truncates the result.

18. The method of claim 16, wherein:
said mapping of possible predicted values to microbins is a non-linear mapping; and
said non-linear mapping is determined from known trends in the distribution of actual outcomes to increase the equality of population of said microbins.
